(19) United States
(12) Patent Application Publication
(10) Pub. No.: US 2023/0004776 A1
(43) Pub. Date: Jan. 5, 2023

(54) MODERATOR FOR IDENTIFYING DEFICIENT NODES IN FEDERATED LEARNING

(71) Applicant: Telefonaktiebolaget LM Ericsson (publ), Stockholm (SE)

(72) Inventors: Perepu SATHEESH KUMAR, Chennai (IN); Saravanan M, Chennai (IN)

(73) Assignee: Telefonaktiebolaget LM Ericsson (publ), Stockholm (SE)

(21) Appl. No.: 17/782,079

(22) PCT Filed: Dec. 5, 2019
(86) PCT No.: PCT/IN2019/050883

§ 371 Date: Jun. 2, 2022

(51) Int. Cl. G06N 3/04; G06K 9/62

(52) U.S. Cl. CPC G06N 3/04; G06K 9/6262

(57) ABSTRACT

A method for detecting and reducing the impact of deficient nodes in a machine learning system is provided. The method includes receiving a local model update from a first local client node; determining a change in accuracy caused by the local model update; determining that the change in accuracy is below a first threshold; and in response to determining that the change in accuracy is below the first threshold, sending a request to the first local client node signaling the first local client node to compress local model updates.

### TECHNICAL FIELD

Disclosed are embodiments related to federated learning using a moderator.

### BACKGROUND

Recently, machine learning has led to major breakthroughs in various areas, such as natural language processing, computer vision, speech recognition, and Internet of Things. Machine learning can be advantageous for tasks related to automation and digitalization. Much of the success of machine learning has been based on collecting and processing large amounts of data in a suitable environment. For some applications of machine learning, the amount and types of data collected can be implicate serious privacy concerns.

For example, consider the case of a speech recognition task, where the object is to predict the next word uttered by the user. This is very specific to the particular user and generalizing requires data to be transferred to the cloud from the user. This can cause privacy concerns and possibly generate doubt or distrust in the end users. Other examples of sensitive data involve applications touching medical data, financial records, or location (or tracking) information.

One recent approach to managing user privacy with machine learning is the introduction of the federated learning approach. Federated learning is a new approach to machine learning where the training data does not leave the users' computer at all. Instead of sharing data, users compute weight updates themselves using locally available data stored on local client nodes or computing devices, and then share those weight updates (not the underlying data) with a central server node or computing device. Federated learning is therefore a way of training a central model without a central server node having to directly inspect users' local data. Federated learning is a collaborative form of machine learning where the training and evaluation process is distributed among many users, taking place on local client nodes. A central server node has the role of coordinating everything, but most of the work is not performed by the central server node but instead by a federation of distributed users operating local client nodes.

In typical federated learning approaches, after a central model is initialized, a certain number of local client nodes are randomly selected to improve the central model. Each sampled local client node receives the current central model from the central server node; and each sampled local client node uses its locally available data to compute an update to that model. All of these local updates are then sent back to the central server node where they are combined (e.g., by averaging, weighted by the number of training examples that the local nodes used). The central server node then applies this combined update to the central model, typically (in the case of neural network models) by using some form of gradient descent.

Neural networks commonly have millions of parameters. Sending updates for so many values to a central server node may lead to an inordinate communication cost, especially as the number of users and iterations of training increases. Thus, a naive approach to sharing weight updates is not feasible for larger models. Since uploads are typically much slower than downloads, it is acceptable that local client nodes have to download the full, uncompressed current model. For sending updates, however, local client nodes may be required to use compression methods.

Both lossless and lossy compression methods can be used. Other approaches to managing updates (in addition to, or as alternatives to compression) can also be used, such as only sending updates when a good network connection is available. Additionally, specialized compression techniques for federated learning may be applied. For example, because in some methods of federated learning only a combined update (e.g., averaged over each of the local updates) is required to compute the updated central model, federated-learning specific compression methods may try to encode updates with fewer bits while keeping the combined update (e.g., average) stable. In this circumstance, it may therefore be acceptable that individual updates are compressed in a lossy manner, as long as the overall combination (e.g., average) does not change too much.

Compression algorithms for federated learning can generally be put into two classes: “sketched” updates and “structured” updates. Sketched updates refer to when local client nodes compute a normal weight update and perform a compression after the update is computed. The compressed update is often an unbiased estimator of the true update, meaning they are the same on average (e.g., probabilistic optimization). Structured updates refer to when local client nodes perform compression as part of generating the update. For example, the update may be restricted to be of a specific form that allows for an efficient compression. As one example, the updates might be forced to be sparse or low-rank. The optimization then finds the best possible update of this form.

There are no strong guarantees about which method (“sketched” or “structure”) works the best. In the general case, it depends heavily on a particular application and the distributions of the updates at the local client nodes. Like in many parts of machine learning, different methods can be tested and are compared empirically.

### SUMMARY

In a typical federated learning implementation, it is difficult to select local client nodes or computing devices to provide updates to the central model. In the worst case, assume that a user is malicious, and actively wants to update the central global model with low quality data from the malicious user's local client node or computing device. In this case, the accuracy of the central model decreases, and this decrease will affect other users also, since the central model is shared with the local client nodes or computing devices of all users. Current approaches attempt to handle this situation by either discarding the updates from the malicious user or using an optimization framework to lessen the effect of a malicious user's updates of the central model. However, in both cases, the malicious user is identified based on the history of the user. This approach is problematic because, for example, it takes time to identify a malicious user, and it also fails to account for non-malicious users who may have occasional periods of poor, deficient or unusual quality data (such that the data does not improve other users' performance).

Embodiments disclosed herein are applicable to not just malicious users, but also users who are not malicious but may have poor, deficient or unusual quality data (such that the data does not improve other users' performance). For example, a user's local data may degrade its own model. Additionally, while a user's local data may locally improve its own performance, if the data is too specific or not generally applicable to other users, the data could cause degradation of the central model. Since, a user's local data is continually being added to, over time the data may become better, and more generally applicable to other users, such that the data may be considered as of good quality. Therefore, completely discarding the user may not be an optimal approach. But treating the user having poor or deficient quality data as any other user may not be optimal either, since a user's data in such circumstances can degrade the central model. Embodiments address this problem by compressing the updates of users with poor or deficient quality data before sending the updates to the global model. Embodiments also differentiate between malicious users, who may want to actively upload bad updates, and poor performing or deficient users, who may inadvertently upload updates that would degrade the central model.

Another problem with typical federated learning approaches, is that the compression such approaches use to compress local model updates can lose much of the important information in the update. Embodiments disclosed herein also provide for improved compression methods for local model updates. Such embodiments may include computing which neurons are firing the most (e.g., contributing the most to the model), selecting those neurons, and sending these selected neurons as the compressed local model update. In this way, the effect of the updates can be maximized on the central model, and bandwidth needed for transmission of the full update is also saved.

According to a first aspect, a method for detecting and reducing the impact of deficient (or poor-performing) nodes in a machine learning system (e.g., a federated learning system) is provided. The method includes: receiving a local model update from a first local client node; determining a change in accuracy caused by the local model update; determining that the change in accuracy is below a first threshold; and in response to determining that the change in accuracy is below the first threshold, sending a request to the first local client node signaling the first local client node to compress local model updates.

In some embodiments, the method is performed by a moderator node interposed between the first local client node and a central server node controlling the machine learning system. In some embodiments, the method further includes sending a representation of the local model update to a central server node. In some embodiments, the method further includes receiving a compressed representation of the local model update from the first local client node, and wherein the representation of the local model update sent to the central server node comprises the compressed representation.

In some embodiments, the method further includes: receiving additional local model updates from the first local client node; determining additional changes in accuracy caused by the additional local model updates; determining that the additional changes in accuracy corresponding to a number of the additional local model updates are below the first threshold, wherein the number of the additional local model updates exceeds a second threshold; and in response to determining that the additional changes in accuracy corresponding to the number of the additional local model updates are below the first threshold, treating the first local client node as malicious such that local model updates from the first local client node are not sent to the central server node.

In some embodiments, the method further includes determining a level of compression, wherein the request includes an indication of the level of compression. In some embodiments, determining a level of compression comprises running a machine learning model. In some embodiments, the request comprises an indication of a compression process. In some embodiments, the compression process comprises choosing a set of top-scoring neurons. In some embodiments, the compression process comprises the method according to any one of the embodiments of the second aspect.

According to a second aspect, a method for a local client node participating in a machine learning system (e.g., a federated learning system) for compressing a local model of the local client node is provided. The method includes: for each sample s of a plurality of training samples, obtaining an output mapping Mₛ such that for a given neuron n of layer l in the local model, Mₛ(n, l) corresponds to the output of the given neuron n of layer l; obtaining a combined output mapping M such that for a given neuron n of layer l in the local model, M(n, l) corresponds to a combined output of the given neuron n of layer l; and selecting a subset of neurons based on the combined output mapping M.

In some embodiments, the combined output M(n, l) of the given neuron n of layer l is an average of Mₛ(n, l) for each sample s of the plurality of training samples. In some embodiments, selecting a subset of neurons based on the combined output mapping M comprises selecting the top x neurons having the highest combined output. In some embodiments, the method further includes sending the selected subset of neurons to a central server node as a compressed representation of the local model.

According to a third aspect, a moderator node for detecting and reducing the impact of deficient (or poor-performing) nodes in a machine learning system (e.g., a federated learning system) is provided. The moderator node includes a memory; and a processor. The processor is configured to: receive a local model update from a first local client node; determine a change in accuracy caused by the local model update; determine that the change in accuracy is below a first threshold; and in response to determining that the change in accuracy is below the first threshold, send a request to the first local client node signaling the first local client node to compress local model updates.

According to a fourth aspect, a local client node participating in a machine learning system (e.g., a federated learning system) is provided. The local client node includes a memory; and a processor. The processor is configured to: for each sample s of a plurality of training samples, obtain an output mapping Mₛ such that for a given neuron n of layer l in the local model, Mₛ(n, l) corresponds to the output of the given neuron n of layer l; obtain a combined output mapping M such that for a given neuron n of layer l in the local model, M(n, l) corresponds to a combined output of the given neuron n of layer l; and select a subset of neurons based on the combined output mapping M.

According to a fifth aspect, a computer program is provided comprising instructions which when executed by processing circuitry causes the processing circuitry to perform the method of any one of the embodiments of the first or second aspects.

According to a sixth aspect, a carrier is provided containing the computer program of the fifth aspect, wherein the carrier is one of an electronic signal, an optical signal, a radio signal, and a computer readable storage medium.

### BRIEF DESCRIPTION OF THE DRAWINGS

The accompanying drawings, which are incorporated herein and form part of the specification, illustrate various embodiments.

FIG. 1 illustrates a federated learning system according to an embodiment.

FIG. 2 illustrates a flow chart according to an embodiment.

FIG. 3 illustrates a message diagram according to an embodiment.

FIG. 4 is a flow chart according to an embodiment.

FIG. 5 is a flow chart according to an embodiment.

FIG. 6 is a block diagram of an apparatus according to an embodiment.

FIG. 7 is a block diagram of an apparatus according to an embodiment.

### DETAILED DESCRIPTION

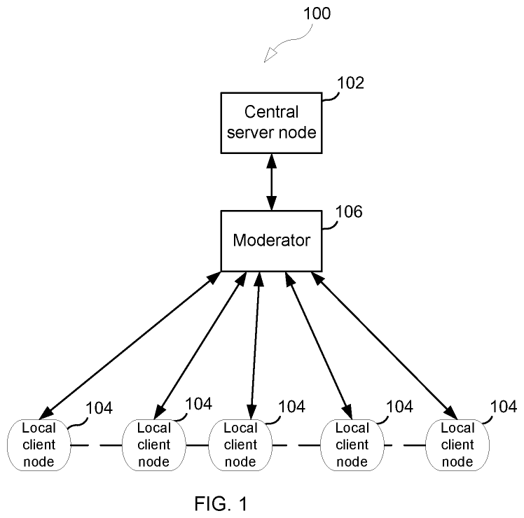

FIG. 1 illustrates a system 100 of machine learning according to an embodiment. As shown, a central server node or computing device 102 is in communication with one or more local client nodes or computing devices 104 via moderator 106. Optionally, local client nodes or computing devices 104 may be in communication with each other utilizing any of a variety of network topologies and/or network communication systems. For example, local client nodes 104 include user computing devices such as a smart phone, tablet, laptop, personal computer, and so on, and may also be communicatively coupled through a common network such as the Internet (e.g., via WiFi) or a communications network (e.g., LTE or 5G). Central server nodes 104 may include computing devices such as servers, base stations, mainframes, and cloud computing resources. While a central server node or computing device 102 is shown, the functionality of central server node 102 may be distributed across multiple nodes, and may be shared between one or more of local client nodes 104.

Moderator 106 may sit between the central server node 102 and the local client nodes 104. Moderator 106 may be a separate entity, or it may be part of central server node 102. As shown, each local client node 104 may communicate model updates to moderator 106, moderator 106 may communicate with central server node 102, and central server node 102 may send the updated central model to the local client nodes 104 through moderator 106. The link between local client nodes 104 and moderator 106 is shown as being bidirectional between those entities (e.g. with a two-way link, or through a different communication channel). Although not shown, there may be a direct communication link between central server node 102 and local client nodes 104.

Federated learning as described in embodiments herein may involve one or more rounds, where a central model is iteratively trained in each round. Local client nodes 104 may register with the central server node 102 to indicate their willingness to participate in the federated learning of the central model, and may do so continuously or on a rolling basis. Upon registration (and potentially at any time thereafter), the central server node 102 transmit training parameters to local client nodes 104. The central server node 102 may transmit an initial model to the local client nodes 104. For example, the central server node 102 may transmit to the local client nodes 104 a central model (e.g., newly initialized or partially trained through previous rounds of federated learning). The local client nodes 104 may train their individual models locally with their own data. The results of such local training may then be reported back to central server node 102, which may pool the results and update the global model. Reporting back to the central server node 102 may be mediated by moderator 106. This process may be repeated iteratively. Further, at each round of training the central model, central server node 102 may select a subset of all registered local client nodes 104 (e.g., a random subset) to participate in the training round.

Embodiments provide a new federated learning approach that effectively handle both malicious users and users with poor or deficient quality data. In some embodiments, a moderator node 106 sits between the central server node 102 (which handles updates to the central model) and local client nodes 104 (which individually handle updates to their respective local models). The moderator node 106 may monitor the incoming local model updates from the local client nodes 104; the moderator 106 may also check the authenticity and quality of the local client node 104 and the data from the local client node 104.

In some embodiments, the moderator 106 may accept all local model updates that it receives from local client nodes 104 during an initial phase. The moderator may keep its own cached version of the central model, separate from that maintained by the central server node 102. The updates that the moderator 106 receives from local client nodes 104 may be used to update the moderator's 106 cached version of the central model. The moderator 106 may, after updating its cached version of the central model with one or more local model updates, select local client nodes 104 (e.g., randomly, based on a trusted list of local client nodes 104, or otherwise) and send the moderator's 106 updated version of the central model to those selected local client nodes 104. Those selected local client nodes 104 may then report back to the moderator 106 on how their respective local models performed with their local data. This is one example for how the moderator 106 may determine a change in accuracy caused by one or more local model updates.

The moderator 106 may use various techniques to determine a change in accuracy. For example, the moderator 106 may average the changes in accuracy at each of the local client nodes 104 selected to report on the accuracy, the moderator 106 may weigh the average based on the history of such local client nodes 104, the moderator 106 may discount outliers, and so on. For example, the moderator 106 may determine if an accuracy of most or all of the selected local client nodes 104 is decreased, or if there is a mixed result such that some have increased and some decreased. Accordingly, moderator 106 may determine a change in accuracy, which may be a scalar value indicating direction (e.g., increase or decrease), and moderator 106 may additionally determine other information related to the change in accuracy (e.g., statistical information related to the individual changes in accuracy from the selected local client nodes 104).

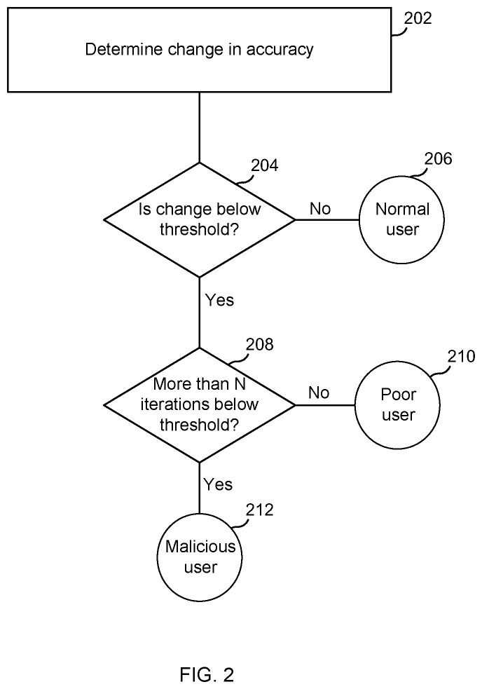

Depending on the reduction or increase in accuracy, the moderator 106 may label a certain local client node 104 as malicious or as performing poorly or deficient. For example, consider the flow chart illustrated in FIG. 2. The moderator 106 may determine the change in accuracy at 202. At 204, the moderator 106 considers the change in accuracy, and determines whether it is below a threshold (e.g., degrading by X % or more, such as by more than 3%). If the change in accuracy is not below the threshold (e.g., the change is positive, or not very negative), then the local client node 104 may be labeled as a normal user at 206. If, on the other hand, the change is below a threshold, then moderator 106 may consider how often the change has been below a threshold at 208. If the local model updates from a given local client node 104 are frequently poor (e.g., continuously degrading by the threshold amount for N or more iterations, such as N=10), the moderator 106 may then determine that the local client node 104 responsible for those poor local model updates is malicious at 208. In some embodiments, instead of requiring the poor performance to be continuous, moderator 106 may label a node as malicious if the poor performance below the threshold has continued for too long by some other metric, such as for 0 of the last N iterations (e.g., 8 of the last 10 iterations). On the other hand, if the local model update is performing poorly, but the local client node 104 does not rise to the level of being malicious, the moderator 106 may (e.g., temporarily) label the local client node 104 as performing poorly at 210.

In some embodiments, moderator 106 may determine additional factors besides the number of times the local client node 104 has been poorly performing or deficient in making a determination of maliciousness. For example, the moderator 106 may be able to determine if a local client node's 104 updates generally perform well for a small subset of the other local client nodes 104, but performs poorly or deficiently for most other local client nodes 104. This may indicate that the local client node 104 is not malicious, but may be receiving data that is of unusual or poor or deficient quality for other local client nodes 104. This may warrant additional compression of the local client node 104, but may not in some embodiments warrant completely discarding that local client node's 104 updates.

In some embodiments, if a local client node 104 is identified as malicious, then the moderator 106 does not accept local model updates from that local client node 104, and does not send such local model updates to the central server node 102 for updating the central model. In some embodiments, if a local client node 104 is identified as performing poorly or deficiently (but is not malicious), the local client node 104 will be requested to send a compressed version of its local model updates (e.g., to moderator 106 or to central server node 102). In some embodiments, the moderator 106 may compress the local model updates of the local client node 104 and send the compressed version to the central server node 102 itself.

In some embodiments, the type of compression requested from the local client node 104 that is identified as performing poorly or deficiently is to have the local client node 104 send only top firing neurons to update the central model instead of all the weights. This is a type of structured compression as the model will update only with subset of weights. The moderator 106 may, in some embodiments, decide on the nature and level of the compression, such as how many weights need to be updated and how many weights need to be discarded. This information may be included in the request that the moderator 106 sends to the local client node 104.

Such compression may also be useful more generally in the case of local client nodes 104 who have low bandwidth to send local model updates.

To identify compression parameters (e.g., the level of compression to be used), a machine-learning model may be used. The machine-learning model may take additional factors of the local client node 104 into account to decide on the level of compression. In some embodiments, the level of compression may be determined based at least in part on the change in accuracy. For example, some embodiments may initially determine the level of compression based on the change in accuracy, and then switch to using the machine-learning model after it has seen enough data to be suitably trained.

In some embodiments, the compression method of updating only the most firing neurons may proceed in the following manner. As an initial matter, any neuron output can be represented by the equation below:

y=ƒ(Σwx+b)

where w represents the weights of the neurons in the previous layer, b represents the bias of the neurons, and ƒ represents the activation function. In the equation, x represents the input to the given neuron. In the first hidden layer, this (x) will be the input to the network; in subsequent layers, this (x) will be the output of previous hidden layer. With this background, the compression method (for compressing an update to a given local model) will now be described.

1. First, for one sample in the training data, the local model is trained, such that the model weights are obtained. In addition, every neuron output in every layer of the local model is also obtained. This collection of neuron outputs is referred to here as an output mapping; the output mapping maps a given neuron n of layer l to a specific output for a given sample s. For example, the outputs for one sample may be noted as in the following table:

| Layer | Neuron | Output |
|---|---|---|
| 1 | 1 | 0.1 |
| 1 | 2 | 0.8 |
| 2 | 1 | 0.7 |

(As previously noted, a neural network may have millions of parameters, resulting in the above table being much larger than shown. Additionally, a local client node 104 may store an output mapping as above in any suitable format.)

2. This is repeated for every training sample that the local client node 104 has, resulting in tables (output mappings) as shown above for each of the training samples.

3. A combined output mapping is then obtained from each of the sample-specific output mappings. For example, the combined output mapping may take the average output for each neuron n of layer l, averaged over all of the samples s of the training data. Other methods of combining the sample-specific output mappings may also be used.

4. From the combined output mapping, the top-performing neurons are selected. For example, the top N neurons based on the highest combined output value may be selected (e.g., N=10, 20).

5. These selected neurons then represent the most firing neurons for the local model.

There are various ways of controlling the level of compression using the most firing neurons approach. For example, one parameter to decide is how many weights to update in the model. Embodiments, for example, may cover X % (e.g., 50%) of the neuron weights which cover X % (e.g., 50%) of the weights in the local model, rather than updating the entire local model. This can result in some of the updates being learned by the central model, rather than everything from the local client node 104 being discarded. In this way, the central model can learn some of the local model updates from the local model.

The level of compression may be an important parameter to control, as it can impact the affect that poor performing or deficient nodes have on the central model, as well as the impact that malicious nodes can have prior to their detection as being malicious. In some embodiments, when a poor performing or deficient node is detected, the level of compression may increase for that node as it continues to send poor performing or deficient updates. For example, it may take N iterations before determining that a given node is malicious, and the compression level for that node may increase at each iteration until the node is finally identified as malicious and updates from that node are no longer accepted. On the other hand, if a poor performing or deficient node starts to have good (or better) model updates (that is, if the change in accuracy is not as bad as previously, or even has a positive impact on accuracy), then the level of compression may be reduced until the node is no longer considered a poor performing or deficient node and is not required to send compressed updates. In general, the level of compression may be selected manually, it may be selected based on a set of predetermined rules, or it may be selected based on a machine-learning model evaluating a number of different input parameters.

As an example of determining the level of compression, consider the case where a local client node 104 sends an update of its local model to moderator which 106, and the update decreases the accuracy by p % (as reported to moderator 106 by other local client nodes 104). The moderator 106 may penalize the local client node 104 by requiring the local client node 104 to compress its local model update by p % (the same amount as the drop in accuracy). In some embodiments, this compression may involve the local client node 104 collecting the most firing neurons which cover p % of the local model to determine the local model update. In some embodiments, the level of compression may be proportional to the change in accuracy, optionally capped at a certain value. For instance, the level of compression may be max(X %, k*p %), where X and k can be any value, e.g. X=60, and k=2.

As an example of compressing the local model update, for instance to cover a particular percentage of the local model, consider the case where there are 100 neurons in the local model, and where summing the absolute values of all weights results in 96.5. In this case, in order to compress the local model update by 50%, a local client node 104 may add the absolute values of weights starting from most firing neurons until the absolute sum of weights reaches or exceeds 48.25 (i.e. 96.5*50%). The local client node 104 may then send only these neuron weights (i.e., only the most firing neurons contributing to the sum) as a local model update. In this way, the central model may be able to learn something from the local model characteristics (that is, the local model update is not entirely discarded), but the impact from a poor performing update may be muted.

In some embodiments, the level of compression may be determined by a machine-learning model. This model may need a sufficient amount of data points in order to perform optimally, and therefore in some embodiments a different method (such as a rule-based method using the change in accuracy to determine the level of compression) may be used during the initial training period. The model used may accept a number of inputs, such as a change in accuracy, the number of weights used in the local model, the location of the local client node 104, the trustworthiness of the local client node 104, and so on. The model may take the form of any type of machine learning model, including a neural network model, a Classification and Regression Tree (CART) model, and so on. The machine learning model allows for the level of compression to be determined dynamically.

### Example

An example was created using one of the embodiments disclosed herein. The example involved a central model implemented for the application of a keyword-prediction task using a long short-term memory (LSTM) models in all the local models. The neural network used in the models consisted of three hidden layers with ten nodes in each of the layers. The model was used to predict the next keyword based on the previous nine keywords. To train the models, the Google keyword prediction public dataset was used.

In the example, ten local client nodes were used. The training data was divided into ten equal parts, one for each of the local client nodes. After ten iterations, the accuracy of the central model reached 82%. In one of the local client nodes, in order to test the effect of an embodiment, bad data was used, such that the data was forced to be independent and identically distributed. If local model updates from the local client node with the bad data are discarded completely (as current approaches to detecting malicious users would do), the accuracy drops to 81%. However, when using an embodiment disclosed herein, where the poor performing or deficient node is forced to compress its local model updates, the accuracy is increased to 84%. Accordingly, it can be advantageous to allow poor performing or deficient nodes to update the central model where those updates are compressed.

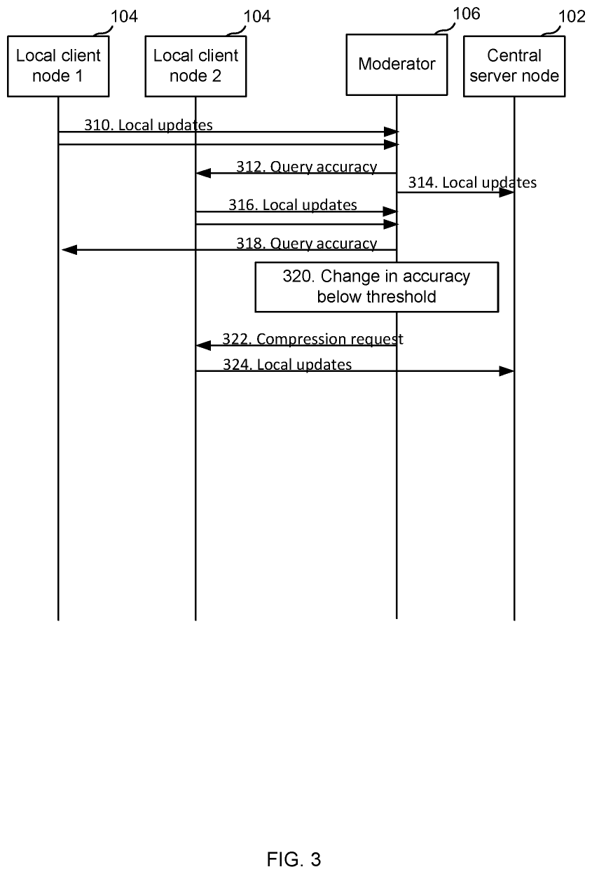

FIG. 3 illustrates a message flow diagram according to an embodiment. At 310, a first local client node 104 sends updates to moderator 106. Moderator 106 may update its cache of the central model using that update, and at 312, query other local client nodes about the accuracy of the updated central model. As shown, moderator 106 queries the second local client node 104, but moderator 106 may also query additional local client nodes 104, and may select the set of local client nodes to query based on information that moderator 106 has regarding the local client nodes 104. In this example, moderator 106 determines that the change in accuracy of the local updates 310 are beneficial, and moderator 106 then forwards the local updates at 314 to the central server node 102. In some embodiments, moderator 106 may instruct the first local client node 104 to send the local updates to the central server node 102.

At 316, the second local client node 104 sends updates to moderator 106. Moderator 106 may update its cache of the central model using that update, and at 318, query other local client nodes about the accuracy of the updated central model. As shown, moderator 106 queries the first local client node 104, but as noted above moderator 106 may also query additional local client nodes 104. In this example, moderator 106 determines at 320 that the change in accuracy is below a threshold. In this example, moderator 106 determines that the second local client node is a poor performing or deficient node, but is not identified as being malicious at this time. Accordingly, moderator 106 sends a compression request to the second local client node 104 at 322. The compression request may indicate the type of compression and level of compression that the second local client node 104 should apply to its local model updates. After receiving the compression request, the second local client node 104 sends a compressed local model update to central server node 102 at 324.

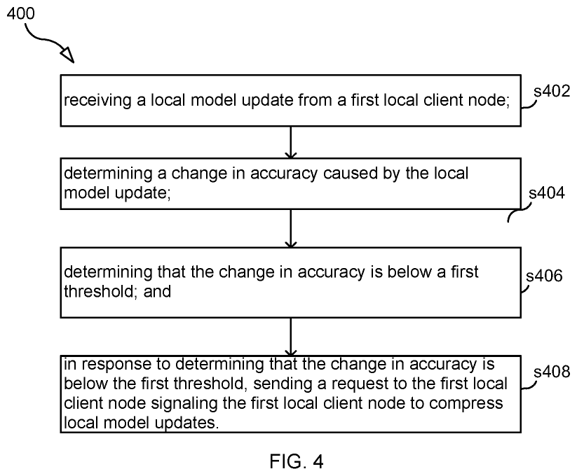

FIG. 4 illustrates a flow chart according to an embodiment. Process 400 is a method for detecting and reducing the impact of poor-performing or deficient nodes in a machine learning system (e.g., a federated learning system). Process 400 may begin with step s402.

Step s402 comprises receiving a local model update from a first local client node 104.

Step s404 comprises determining a change in accuracy caused by the local model update.

Step s406 comprises determining that the change in accuracy is below a first threshold.

Step s402 comprises, in response to determining that the change in accuracy is below the first threshold, sending a request to the first local client node signaling the first local client node 104 to compress local model updates.

In some embodiments, the method is performed by a moderator node 106 interposed between the first local client node 104 and a central server node 102 controlling the federated learning system. In some embodiments, the method further includes sending a representation of the local model update to a central server node 102. In some embodiments, the method further includes receiving a compressed representation of the local model update from the first local client node 104, and wherein the representation of the local model update sent to the central server node 102 comprises the compressed representation.

In some embodiments, the method further includes: receiving additional local model updates from the first local client node 104; determining additional changes in accuracy caused by the additional local model updates; determining that the additional changes in accuracy corresponding to at a number of the additional local model updates are below the first threshold, wherein the number of the additional local model updates exceeds a second threshold; and in response to determining that the additional changes in accuracy corresponding to the number of the additional local model updates are below the first threshold, treating the first local client node 104 as malicious such that local model updates from the first local client node 104 are not sent to the central server node 102.

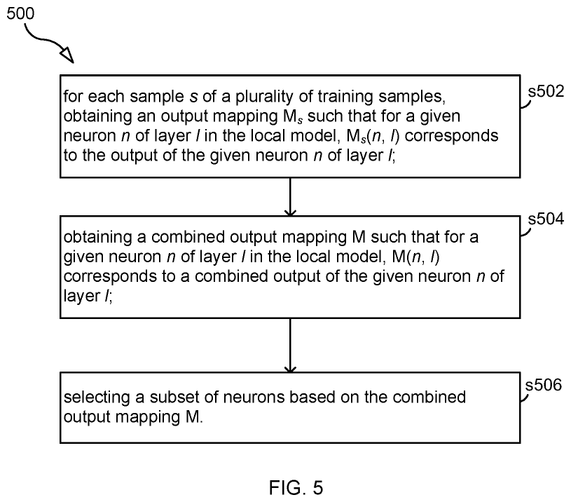

In some embodiments, the method further includes determining a level of compression, wherein the request includes an indication of the level of compression. In some embodiments, determining a level of compression comprises running a machine learning model. In some embodiments, the request comprises an indication of a compression process. In some embodiments, the compression process comprises choosing a set of top-scoring neurons. In some embodiments, the compression process comprises the method according to any one of the embodiments described with respect to FIG. 5, or according to any other compression process described herein.

FIG. 5 illustrates a flow chart according to an embodiment. Process 500 is a method for a node participating in a machine learning system (e.g., a federated learning system) for compressing a local model of the node. Process 500 may begin with step S402.

Step s502 comprises, for each sample s of a plurality of training samples, obtaining an output mapping Mₛ such that for a given neuron n of layer l in the local model, Mₛ(n, l) corresponds to the output of the given neuron n of layer l.

Step s504 comprises obtaining a combined output mapping M such that for a given neuron n of layer l in the local model, M (n, l) corresponds to a combined output of the given neuron n of layer l.

Step s506 comprises selecting a subset of neurons based on the combined output mapping M.

In some embodiments, the combined output M(n, l) of the given neuron n of layer l is an average of Mₛ(n, l) for each sample s of the plurality of training samples. In some embodiments, selecting a subset of neurons based on the combined output mapping M comprises selecting the top x neurons having the highest combined output. In some embodiments, the method further includes sending the selected subset of neurons to a central server node as a compressed representation of the local model.

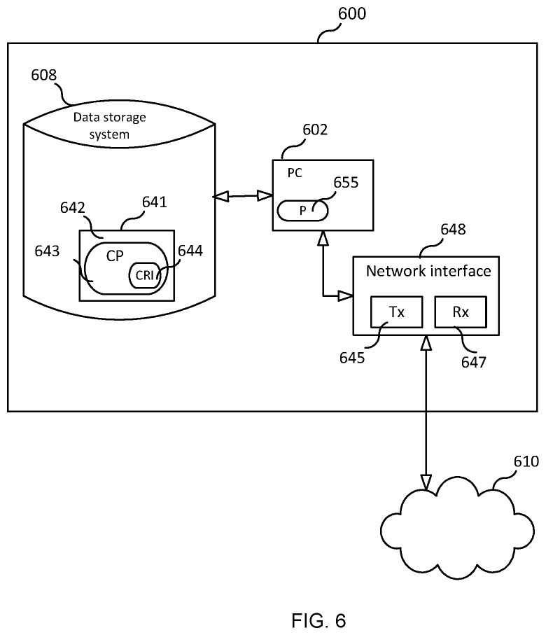

FIG. 6 is a block diagram of an apparatus 600 (e.g., a local client node 104 and/or central server node 102 and/or moderator 106), according to some embodiments. As shown in FIG. 6, the apparatus may comprise: processing circuitry (PC) 602, which may include one or more processors (P) 655 (e.g., a general purpose microprocessor and/or one or more other processors, such as an application specific integrated circuit (ASIC), field-programmable gate arrays (FPGAs), and the like); a network interface 648 comprising a transmitter (Tx) 645 and a receiver (Rx) 647 for enabling the apparatus to transmit data to and receive data from other nodes connected to a network 610 (e.g., an Internet Protocol (IP) network) to which network interface 648 is connected; and a local storage unit (a.k.a., “data storage system”) 608, which may include one or more non-volatile storage devices and/or one or more volatile storage devices. In embodiments where PC 602 includes a programmable processor, a computer program product (CPP) 641 may be provided. CPP 641 includes a computer readable medium (CRM) 642 storing a computer program (CP) 643 comprising computer readable instructions (CRI) 644. CRM 642 may be a non-transitory computer readable medium, such as, magnetic media (e.g., a hard disk), optical media, memory devices (e.g., random access memory, flash memory), and the like. In some embodiments, the CRI 644 of computer program 643 is configured such that when executed by PC 602, the CRI causes the apparatus to perform steps described herein (e.g., steps described herein with reference to the flow charts). In other embodiments, the apparatus may be configured to perform steps described herein without the need for code. That is, for example, PC 602 may consist merely of one or more ASICs. Hence, the features of the embodiments described herein may be implemented in hardware and/or software.

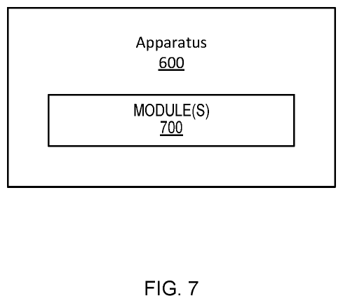

FIG. 7 is a schematic block diagram of the apparatus 600 according to some other embodiments. The apparatus 600 includes one or more modules 700, each of which is implemented in software. The module(s) 700 provide the functionality of apparatus 600 described herein (e.g., the steps herein, e.g., with respect to FIGS. 2-5).

While various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for detecting and reducing the impact of deficient nodes in a machine learning system, the method comprising:
receiving a local model update from a first local client node;
determining a change in accuracy caused by the local model update;
determining that the change in accuracy is below a first threshold; and
in response to determining that the change in accuracy is below the first threshold, sending a request to the first local client node signaling the first local client node to compress local model updates.

2. The method of claim 1, wherein the method is performed by a moderator node interposed between the first local client node and a central server node controlling the machine learning system, and the method further comprises sending a representation of the local model update to the central server node.

3. (canceled)

4. (canceled)

5. The method of claim 1, further comprising:
receiving additional local model updates from the first local client node;
determining additional changes in accuracy caused by the additional local model updates;
determining that the additional changes in accuracy corresponding to a number of the additional local model updates are below the first threshold, wherein the number of the additional local model updates exceeds a second threshold; and
in response to determining that the additional changes in accuracy corresponding to the number of the additional local model updates are below the first threshold, treating the first local client node as malicious such that local model updates from the first local client node are not sent to the central server node.

6. The method of claim 1, further comprising determining a level of compression by running a machine learning model, wherein the request includes an indication of the level of compression and an indication of a compression process.

7. (canceled)

8. (canceled)

9. The method of claim 6, wherein the compression process comprises choosing a set of top-scoring neurons.

10. (canceled)

11. The method of claim 1, wherein the machine learning system is a federated learning system.

12. A method for a local client node participating in a machine learning system for compressing a local model of the local client node, the method comprising:
for each sample s of a plurality of training samples, obtaining an output mapping Mₛ such that for a given neuron n of layer l in the local model, Mₛ(n, l) corresponds to the output of the given neuron n of layer l;
obtaining a combined output mapping M such that for a given neuron n of layer l in the local model, M (n, l) corresponds to a combined output of the given neuron n of layer l;
selecting a subset of neurons based on the combined output mapping M; and
sending the selected subset of neurons to a central server node as a compressed representation of the local model.

13. The method of claim 12, wherein the combined output M(n, l) of the given neuron n of layer l is an average of Mₛ(n, l) for each sample s of the plurality of training samples.

14. The method of claim 12, wherein selecting a subset of neurons based on the combined output mapping M comprises selecting the top x neurons having the highest combined output.

15. (canceled)

16. The method of claim 12, wherein the machine learning system is a federated learning system.

17. A moderator node for detecting and reducing the impact of deficient nodes in a machine learning system, the moderator node comprising:
a memory; and
a processor, wherein said processor is configured to:
receive a local model update from a first local client node;
determine a change in accuracy caused by the local model update;
determine that the change in accuracy is below a first threshold; and
in response to determining that the change in accuracy is below the first threshold, send a request to the first local client node signaling the first local client node to compress local model updates.

18. The moderator node of claim 17, wherein the moderator node is interposed between the first local client node and a central server node controlling the machine learning system and the processor is further configured to send a representation of the local model update to a central server node.

19. (canceled)

20. (canceled)

21. The moderator node of claim 17, wherein the processor is further configured to:
receive additional local model updates from the first local client node;
determine additional changes in accuracy caused by the additional local model updates;
determine that the additional changes in accuracy corresponding to a number of the additional local model updates are below the first threshold, wherein the number of the additional local model updates exceeds a second threshold; and
in response to determining that the additional changes in accuracy corresponding to the number of the additional local model updates are below the first threshold, treat the first local client node as malicious such that local model updates from the first local client node are not sent to the central server node.

22. The moderator node of claim 17, wherein the processor is further configured to determine a level of compression by running a machine learning model, wherein the request includes an indication of the level of compression and an indication of a compression process.

23. (canceled)

24. (canceled)

25. The moderator node of claim 22, wherein the compression process comprises choosing a set of top-scoring neurons.

26. (canceled)

27. The moderator node of claim 17, wherein the machine learning system is a federated learning system.

28. A local client node participating in a machine learning system, the local client node comprising:
a memory; and
a processor, wherein said processor is configured to:
for each sample s of a plurality of training samples, obtain an output mapping Mₛ such that for a given neuron n of layer l in the local model, Mₛ(n, l) corresponds to the output of the given neuron n of layer l;
obtain a combined output mapping M such that for a given neuron n of layer l in the local model, M (n, l) corresponds to a combined output of the given neuron n of layer l;
select a subset of neurons based on the combined output mapping M; and
send the selected subset of neurons to a central server node as a compressed representation of the local model.

29. The local client node of claim 28, wherein the combined output M(n, l) of the given neuron n of layer l is an average of Mₛ(n, l) for each sample s of the plurality of training samples.

30. The local client node of claim 28, wherein selecting a subset of neurons based on the combined output mapping M comprises selecting the top x neurons having the highest combined output.

31. (canceled)

32. The local client node of claim 28, wherein the machine learning system is a federated learning system.

33. (canceled)

34. (canceled)
